(19) United States
(12) Patent Application Publication
(10) Pub. No.: US 2017/0224588 A1
(43) Pub. Date: Aug. 10, 2017

(54) MEDICATION REMINDER SYSTEM AND METHOD, A CONTROL APPARATUS, AND A COMPUTER PROGRAM PRODUCT

(71) Applicant: FOLIUM OPTICS LTD, Bristol (GB)

(72) Inventors: Stephen Kitson, Bristol (GB); John Rudin, Bristol (GB)

(21) Appl. No.: 15/519,155

(22) PCT Filed: Oct. 16, 2015
(86) PCT No.: PCT/EP2015/073987

§ 371 Date: Apr. 13, 2017

(30) Foreign Application Priority Data
Oct. 17, 2014 (GB) 1418484.0

(51) Int. Cl. A61J 7/00; A61J 7/04; G04F 3/06; G06F 19/00

(52) U.S. Cl. CPC A61J 7/0084; G06F 19/3462; A61J 7/0481; A61J 7/0076; G06F 19/3456; G06F 19/3475; A61J 7/0409; A61J 7/0418; A61J 7/0463; G04F 3/06; G04G 13/02

(57) ABSTRACT

A medication reminder system, comprising a control device operable to receive data representing a dosage regime for the medication for use with an electronic tag, the tag communicatively coupled to a display device to be placed on or in association with an item containing the medication, the tag including a transceiver operable to send and receive data to and from the control device, wherein the display device is operable to display an indicator representing the dosage regime or a parameter associated with the dosage regime.

### TECHNICAL FIELD

Aspects relate, in general to a medication reminder system and method, a control apparatus, and a computer program product.

### BACKGROUND

Individuals may be required or advised to ingest or administer medicaments or medication at regular intervals to treat an illness or condition. Typically, in order to optimize medicinal efficacy, such medicaments should be taken or administered as prescribed by a medical professional. For example, certain medicaments may need to be ingested or administered at specific times and/or at specific intervals. For example, a prescription for a particular medicament may direct a patient to take or administer the medicament several times according to a particular regime, which may include spacing doses at prescribed intervals throughout the day.

For many people, particularly for example the elderly, it can be difficult to precisely adhere to a medication regimen. This can be exacerbated for those who concurrently take different medicaments with respective dissimilar ingestion or administration time cycles and dosage amounts.

### SUMMARY

According to an example, there is provided a medication reminder system, comprising a control device operable to receive data representing a dosage regime for the medication for use with an electronic tag, the tag communicatively coupled to a display device to be placed on or in association with an item containing the medication, the tag including a transceiver operable to send and receive data to and from the control device, wherein the display device is operable to display an indicator representing the dosage regime or a parameter associated with the dosage regime. The display device can be a reflective display, such as a reflective liquid crystal display for example, such as a reflective mode guest host liquid crystal display for example. The display can be flexible, and/or can be shaped in any desired way. The data representing a dosage regime for the medication can be transmitted from the control device to the tag. The electronic tag can include input means to provide input data representing confirmation of adherence to the dosage regime. The input means can be passive or active input means. For example, sensors can be provided on or for the tag to generate data in response to user activation (active) or by inferring user activity (passive). The control device can receive or transmit data representing the dosage regime from or to apparatus at a remote location. The apparatus at the remote location can be a cloud-based server. The apparatus can process the data representing the dosage regime to provide an indication representing risk stratification associated with adherence to the dosage regime. A second/additional display device operable to receive data from the control device can be provided. The additional display device can be a summary display operable to display information representing a summary from one or more input sources. The additional display can display data representing a risk stratified summary of the adherence across multiple medications. The data representing the dosage regime can be input to a memory of the electronic tag using the input means. The apparatus can receive data representing multiple dosage regimes for respective ones of multiple different medicaments.

According to an example, there is provided a computer-implemented method for providing a medication reminder, comprising receiving data representing a dosage regime for the medication at a control device for use with an electronic tag communicatively coupled to a display device located on or in association with an item containing the medication, displaying an indicator representing the dosage regime on the display device or a parameter associated with the dosage regime. The data representing a dosage regime for the medication can be transmitted from the control device to the tag. Input data representing confirmation of adherence to the dosage regime can be input or generated using input means of the electronic tag. The input means can be active, and input data can be provided or generated by activating the input means. The input means can be passive, and providing input data can include inferring user activity using one or more sensors, such as an accelerometer and/or light sensor. At the control device, data representing the dosage regime can be received from or transmitted to apparatus at a remote location. The data representing the dosage regime can be processed at a remote cloud-based apparatus, and the processed data can be used to provide an indication representing risk stratification associated with adherence to the dosage regime. The indicator can be displayed on a second, summary, display device. Data from remote cloud-based apparatus for display using the second display device can be received. Data from other feeds of information for display using the second display device can be received. Data representing the dosage regime can be input to a memory of the electronic tag using the input means or in response to data received from the apparatus.

According to an example, there is provided a control apparatus in a medication reminder system, the apparatus operable to receive data representing a dosage regime for the medication for use with an electronic tag, the tag communicatively coupled to a display device to be placed on or in association with an item containing the medication, the tag including a transceiver operable to send and receive data to and from the control apparatus, wherein the display device is operable to display an indicator representing the dosage regime or a parameter associated with the dosage regime.

According to an example, there is provided a computer program product, comprising a computer usable medium having computer readable program code embodied therein, said computer readable program code adapted to be executed to implement a method for providing a medication reminder as provided herein.

### BRIEF DESCRIPTION OF THE DRAWINGS

Embodiments will now be described, by way of example only, with reference to the accompanying drawings, in which:

FIG. 1 is a schematic representation of a system according to an example;

FIG. 2 is a schematic representation of a message flow for a system according to an example;

FIG. 3 is a schematic representation of a tag/display combination according to an example; and

FIG. 4 is a schematic representation of a tag/display combination according to an example.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

According to an example, there is provided a medication reminder system including a smart electronic tag which can be attached to, incorporated in or otherwise associated with medicine packaging, along with a reminder display device. The tag and the display can be separate, but communicatively coupled, such as by wiring or using wireless technology such as radio-frequency communications for example. The tag and/or the display can be removably attached to the packaging to permit their re-use.

In an alternative example, the tag can be integral with the display. For example, the tag and the display can be encased in a common outer casing portion, and the tag and the display can be communicatively coupled using wiring for example. The integral tag/display device can then be attached to packaging. As noted above, the tag/display device can be removably attached to the packaging to permit re-use.

In either case, the tag can include a wireless transceiver operable to send and receive data over a wireless communications link using radio-frequency (RF) technology, such as a short range RF communications protocol for example that can operate over a range of 0-100 m.

The display can be a low power display that can include colour, and can be used to clearly show a medicament packet to be opened and indicate when a dose of the medicament should be taken. A display can be reflective mode guest-host type of liquid crystal display for example, in which a liquid crystal layer is interposed between a pair of substrates. Other suitable types of low-power consumption display can be used as will be appreciated by those skilled in the art. For example, the display can be an emissive display such as a backlit LCD, or an OLED display or LEDs. Reflective displays, however, have low power consumption so that a tag powered by a compact battery can operate for long periods of time. Conventional liquid crystal displays use polarisers and so are typically dark. E-ink displays are brighter and can be used in instances where black and white is acceptable or desirable. Guest host liquid crystal displays are bright and are available in a wide range of colours. The display can include audio capabilities to provide an audio component to a user indication.

In an example, the tag and/or the display can include sensors to detect when a packet that it is attached to is moved or opened. For example, an accelerometer can be provided to detect movement. Movement data representing a direction and/or distance moved, or simply an indication of movement, can be processed or considered in the tag, or transmitted to another location for processing and consideration. In a further example, the location can be transmitted from the tag to another location where it can be processed or considered. In an example, the location of a packet or item can be monitored to determine if it is within or outside of a given area.

In an example, the tag or display can include input means to enable user input. For example, the input means can include one or more buttons to enable a user to select a medicament and input a prescribed dosage regime which can be stored in a memory of the tag and which can be transmitted from the tag. For example, a simple user interface can be provided in which data representing multiple medicaments can be displayed using the display device to enable selection and input by a user. In addition or as an alternative to using the input means to input data relating to medication and dosage regimes, such data can be received by the tag and stored in its memory, as will be described in more detail below.

In an example, the input means can be used for active input. For example a button can be depressed by a user, or an accelerometer can be used to detect if the device is specifically shaken by a user. The input means can be passive and used to infer user input. For example, accelerometers can be used to detect if the device is moved, which is suggestive of the package being opened to remove medicament. Light detectors can be used to detect if a package has been opened for example.

In an example, tags and/or displays are lightweight and robust and can continue to function if a packet/item is taken outside of communication range with the control device, such as away from home for example, and could be configured by a pharmacist, carer or user. The display provides a ‘glanceable’ indication of when medication is due, and, according to an example, can include an indication with an escalating degree of urgency (from changing colours, graphics to the use of sound alerts for example). According to an example, a tag can connect to a cloud service, either directly or via a control device, which can be provided in the form of a system hub for example. A display, such as an additional summary display for example, can show other feeds such as activity or weight tracking to help users engage with improving their overall health. In an example, an additional display device, which can act as a summary display to display a summary of indications and/or data from other data feeds for example, that is communicatively coupled to either a tag or a control device can provide reminder information in addition to a display on or associated with a package/item. For example, if multiple medicaments are provided, the additional display can be used to provide a consolidated view of adherence to a dosage regime for individual ones of the medicaments, and/or provide a consolidated view of reminders for the medicaments. For example, the additional display can show when medicine is next due, but may not necessarily show which one is due.

Alternatively, the additional display can provide information for respective ones of multiple medicaments to display when doses are due and adherence information for the medicaments.

Data feeds from commercially available activity monitors can be integrated with a display, such as an additional summary display for example, to display data representing user activity and other information such as the user's blood pressure and so on. Typically, for example, such devices are typically able to communicate data using short range RF wireless communications protocols, such as Bluetooth or ZigBee. Accordingly, a display can be paired with such devices and used to relay or display information from the activity monitor as desired. A display can also connect to a cloud service for that activity device, rather than pairing directly to the device, which may be a more likely case for a commercially available tracker for example.

Families or other stakeholders could have duplicate summary displays so that they can see at a glance the current status of adherence to one or more dosage regimes for an individual. They might also have a similar display to monitor their own activity, and in an example users can share their status with each other. Information can be provided to a duplicate display using data received from the cloud service. In an example, an additional display can undergo a authentication process in order to enable it to validly receive data to enable a stakeholder to monitor adherence to one or more dosage regimes. An authentication process can include displaying a number on the additional display, and entering the same number using input means on the duplicate display. The two numbers, if matching, can provide a simple authentication protocol that can be used to validate the use of the duplicate display. Other alternatives, including more robust and sophisticated authentication and validation methods can be used as will be appreciated.

In an example, a control device can connect multiple tags, respective ones of which are associated with or provided on various different packages or items of medicament, to a cloud-based database apparatus to enable data representing adherence to dosage regimes to be monitored by a third party, such as a medical practitioner or other third party with access to the apparatus for example. In an example, tags can communicate with a hub or control device using wireless short range RF communications, and the control device can communicate with the cloud-based apparatus using a wireless telecommunications link such as 3G or 4G for example, or by using WiFi to connect the hub to the internet for example. As noted above, cloud-based database apparatus can thus be used to provide information over the internet for example to a duplicate display.

In an example, tags can be semi-autonomous, re-synchronising with a control device when communications are available. Data provided at the cloud-based apparatus can provide a more detailed view online for clinicians. It can include risk stratification, e.g. a traffic light scheme; green if the patient is taking their medications regularly, and is active, amber might be triggered if the medicine taking is erratic or activity has dropped, and red might indicate a prolonged period of missed doses for example.

A range of feedback mechanisms for an attached tag can be provided, in connection with a display device or a summary display, which can include a reflective or emissive display and which can include audio capabilities. For example, an ‘always-on’ reflective display device can be provided, and/or flashing lights and/or audio signals can be used. Graphics and shaped displays can be used rather than just text and numbers, and an appropriate colour can be chosen for the display (for example, blue becomes harder to see with age and may therefore be avoided).

In an example, a user can confirm which medicine they have taken by pushing a button on the tag. Data representing the actuation of the input means such as the button can be transmitted from the tag to the control device. The transmission can be effected as soon as the data is generated at the tag, or can be sent periodically for example.

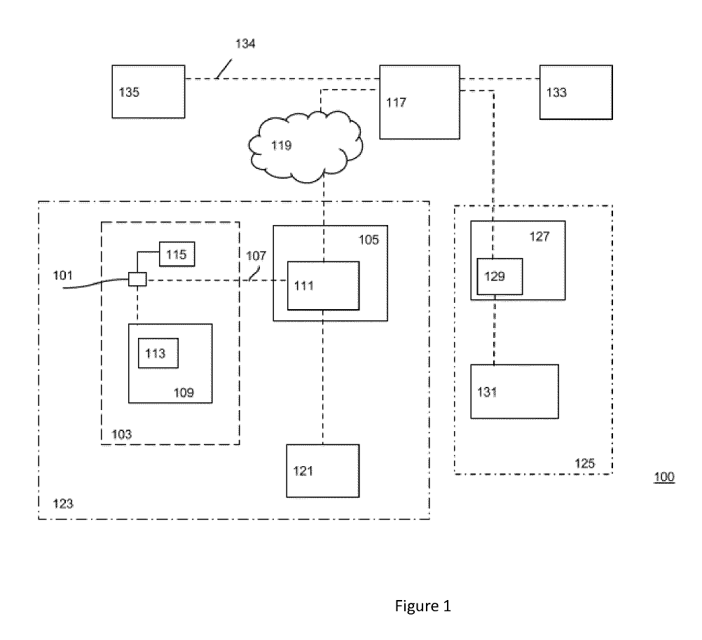

FIG. 1 is a schematic representation of a system according to an example. In a medication reminder system, 100, an electronic tag 101 is shown in place on or in association with an item 103 containing the medication. A control device 105 is provided, and is operable to receive data 107 representing a dosage regime for the medication from the tag 101. In the example of FIG. 1, the tag 101 is communicatively coupled to a flexible display device 109 which is placed on or in association with the item 103. The tag 101 includes a transceiver (not shown) operable to send and receive data to and from a transceiver III of the control device 105. The display device 109 is operable to display an indicator 113 representing the dosage regime associated with the medicament of the item 103 or a parameter associated with the dosage regime. For example, the indicator 113 can be a specific indication of an amount and/or time for a dose of the medicament, or can more generally be a graphical indication that a dose has been taken, needs to be taken, or is to be taken at some point. A simple example can be that the indication 113 is a traffic light system. A green light or graphical element can indicate that a dose has been taken and the user therefore need take no action. An amber light can indicate that a dose should now be taken, or that the time for taking a dose is approaching. In this connection, a predefined time period can be provided in relation to the amber indication to define when the colour indication should appear, such as 1-60 minutes before the dose is due to be taken for example. A red indicator can indicate that a dose has been missed. For example, if the elapsed time from when a dose should have been taken exceeds a predefined threshold value, such as 1-60 minutes for example, the indicator can turn red. The level of warning can escalate as time increases, such as by introducing sound and or other indicators such as flashing images for example. In an example, the control device can, in the event of missed dose, send a signal to the apparatus 117 which can be used to alert a medical practitioner or other stakeholder for example.

The provision of a flexible display enables the display to be attached to the item 103 in a number of ways. For example, if the item 103 is a bottle containing pills for example, the display 109 can be attached to the curved surface of the bottle and follow its contours. In an example, the display may be provided in a lightweight frame which can be placed on or associated with, such as affixed to, the item 103. For example, a length of elastic material, cord or other suitable length of material, which can be provided in a loop, can be used to affix the display to the item. Alternatively, the display may include an adhesive portion that can be used to affix the display to the item. Other suitable ways for releasably attaching the tag and/or display to the item can be provided. For example, hook and eye attachments can be used, or the tag and/or display can be attached to the item using vacuum overmolding and so on.

A dosage regime or routine can include a prescribed dose and frequency of a medicament, as well as time information, and can include when a dose has been taken. In an example, real time analysis of data representing a dosage regime can be provided, such as determining if a dose is to be taken soon, now or should have been taken already. The display on the tag can show the dosage regime, and can cover timely information about the current dose. In an example, data representing a dosage regime can include date representing a log of actual doses taken.

In an example, the display device is operable to display an indicator representing the dosage regime or a parameter associated with the dosage regime. That is, for example, it can display information relating to the current status of the medication relative to that dosage regime. The display of an indicator can be a real time display that updates as and when the current status of a medicament changes relative to a dosage regime. For example, if a dosage regime specifies that a user takes a 100 mg dose of a medicament, corresponding to a single pill for example, at 4 hourly intervals, the indicator can show any one or more of;
Whether the medicament should be taken at the current time, is due to be taken soon, or should have been taken already;
the dose to be taken next, such as one pill, or 100 mg, with a graphical indication to aid the user, such as a picture of a pill, or of the medication package and so on;
the identity or name and so on of the medicament;
the time until the next dose is due, which may be dynamic and count down for example until the time for the next dose is due;
the elapsed time since the last dose, which may be dynamic and increase as time progresses until the next dose for example;
the overall period of time for which the medicament is to be taken and/or the amount of medicament for a course, e.g. for a specific course of a medicament, an indication can show how much of the course has been taken or has elapsed and how much remains;
indicate the time that the last dose of a particular medicament was taken;
indicate that a dose should not be taken.

Any one or more of the above can be indicated to a user using the display device and/or an additional summary display as desired. The indications can update in real time as and when any one or more of the above changes or is updated.

The electronic tag 101 includes input means 115 to provide user input data representing, for example, confirmation of adherence to the dosage regime for the medicament of the item 103. In an example, the input means 115 is a button, actuation of which causes the tag 101 to generate data representing user input. The generated data can be used by the tag to cause a change of display on the display 109. For example, information 113 on display 109 can be updated to reflect the fact that a user has actuated means 115 thereby providing confirmation of adherence to a dosage regime. In an example, the display can be updated so that the confirmation includes or precedes display of information indicating when the next dose of a medicament will be required, or providing a reminder for the same in the same context as previously, for example with an increasing degree of urgency as the time for the dose approaches. In this connection, it will be appreciated that the tag 101 can include functionality such as a timer to countdown between dosage intervals in order to enable the display to be updated to indicate the status of the next dose of the medicament.

In an example, tag 101 includes a memory that can be used to store data representing various items for display as information 113. For example, data for multiple different graphical representations can be provided that can be selected by a processor of the tag 101 (not shown) whereby to enable the information 113 to be changed and updated as required, and enabling the display 109 to be driven by tag 101. The multiple different graphical representations can relate to specific medicaments, and different ones can be geared and selected for display to indicate the status of adherence to a specific dosage regime. For example, different items can be displayed as the interval between doses progresses and culminates in a final reminder item for display.

In an example, the control device 105 can provide data representing a dosage regime to apparatus 117 at a remote location. For example, apparatus 117 can be a cloud-based server at a remote location that can be communicated with via a network 119 such as the internet for example. Transceiver III of the control device 105 is operable to communicate using a wireless communications protocol such as WiFi or a telecommunications protocol to communicate with the network 119 in order to provide data to and receive data from the apparatus 117. The memory of the tag 101 can be updated with data received from apparatus 117. An update can be performed on the basis of a request from tag 101, such as periodically checking for new items to download for example, or in response to new items for example, as is typical.

In an example, apparatus 117 can process data representing a dosage regime and/or adherence to the regime to provide an indication representing risk stratification associated with adherence to the regime. For example, as noted above, a user's adherence to a regime can be categorized based on, for example, actuation of means 115 and the time at which a dose is therefore considered to have been administered or taken. The risk stratification and/or the indicator representing the dosage regime or a parameter associated with the dosage regime can be displayed on the display device 109 and/or a second or summary display device 121, which can act as a consolidated reminder device as described above for a person, family, area, region, or household 123 and so on within which the system is operable.

According to an example, the control device 105 can therefore transmit/receive data from tag 101 and transmit data to display device 121. Multiple devices 101 can be connected to control device 105, and the display 121 can be used, as described above, to provide a consolidated view of the multiple medicaments that a user is taking, including dosage regimes and adherence data for the medicaments. This is therefore provided in addition to individual information displayed on a display device 109, or can be used in place of it.

According to an example, input means 115 can include multiple input devices such as multiple buttons that can be used to select a medicament and input a prescribed dosage regime. For example, a list of medicaments can be stored in a memory of the tag 101 or can be accessed by tag 101 from apparatus 117, for display using display 109. A user can view the list and select a medicament corresponding to that stored in or provided by item 103 to which the tag 101 is attached. The selection can update the memory of the tag 101 to indicate the selected medicament, and a dosage regime can be input using means 115. The apparatus 117 can receive data representing multiple dosage regimes for respective ones of multiple different medicaments, and these can be related to multiple different users who may or may not be at the same location 123.

According to the example of FIG. 1, a second location 125 can receive data from apparatus 117. For example, a control device 127 at location 125 can receive data using a transceiver 129 of the device 127 indicating adherence to one or more dosage regimes associated with one or more users that can be displayed using a device 131 at location 125. For example, the location 125 can be that of a medical practitioner or other stakeholder such as a family member for example, and the data displayed using device 131, which can be the same as that displayed using display 109 or 121 for example, can be used by the interested party at location 125 to monitor the behaviour of the user of a tag 101 for example.

A device 133, such as a computer or smart device such as a phone or tablet for example can be used to remotely configure one or more aspects of a tag and/or display 101/109 via apparatus 117. Remote monitoring of adherence to a dosage regime can also be undertaken using device 133 for example. Data 134 representing one or more of medicaments and their associated prescribed dosage regimes, adherence to a dosage regime, and data relating to an activity monitor can be provided by apparatus 117, having been transmitted by device 105 for example, to an analytics device 135 in order for the data to be processed. Additionally, a device 133 can be used to view a list and select a medicament as well as input or select a dosage regime for the selected medicament, which can then be transmitted to the tag via apparatus 117 for storage in a memory of the tag.

In an example, the input means 115 can be used to indicate adherence to a dosage regime. That is, the input means 115 may be selected to be a simple switch device for example that can be used to effectively reset an interval in a dosage regime in response to user input. As such, data representing medication and dosage regimes can be provided by apparatus 117 and/or device 133. For example, a unique identifier associated with a user can be mapped to a particular medication and dosage regime, such as by a medical practitioner for example. The tag in question, either intermittently, or when it first powered on and within communications range of a control device, can transmit the identifier to the control device. The control device can then forward the identifier to the apparatus 117 which can marry the identifier up with prescribed medication and a corresponding dosage regime that can be transmitted to the tag. A similar process can be used to configure a tag with medication information and a dosage regime using the device 133 for example. That is, the apparatus 117, on receipt of a tag identifier, can forward the identifier or the identifier and associated data such as medication and dosage data to device 133. It can be either be ratified at the device, such as by a medical practitioner or other stakeholder, and released/validated for transmission to the tag. In the event that only an identifier is passed to device 133, the identifier can be married up with prescribed medication and a corresponding dosage regime that can be transmitted to the tag.

In an example, a tag and/or display device can be married to an item/packaging such as by writing a simple number or other identifier on the packaging, or attaching a printed sticker and so, which can also be displayed on the tag/reminder display, such that if they are accidently parted by the user, they can be re-associated without the intervention of a pharmacist/GP/carer and so on.

According to an example, display device 109 and/or 121, 131 can indicate the time that the last dose of a particular medicament was taken and/or that a dose should not be taken.

Furthermore, it is possible that a display can indicate other instructions for a user such as “take to the hub” if the strength of the radio connection has failed or is below a predetermined threshold value. That is, if the medicament and tag are moved away from the control device by a degree which would affect the communication between the devices, the display can indicate that the tag should be moved closer to the control device. For example, the tag can intermittently send a signal to the control device, which can respond with an acknowledgement. Failure to receive the acknowledgement at the tag can indicate that it is out of range of communication of the control device. Accordingly, the tag can provide a signal to the display to indicate that it should be brought closer to the control device. The intermittent signal can continue to be sent, and when an acknowledgement is received from the control device, the instructions can be cleared from the display.

In an alternative implementation, the tag can transmit its status on a regular basis (such as every minute for example) and if it needs interrogation that is flagged in the status and the control device (hub) can connect to it and transfer data. If the tag does not get this transfer within a predetermined timeout (such as 30 seconds for example), then it assumes that it is out of range of the control device and the ‘take to hub’ indicator is turned on. This can be more power efficient than the previously mentioned implementation.

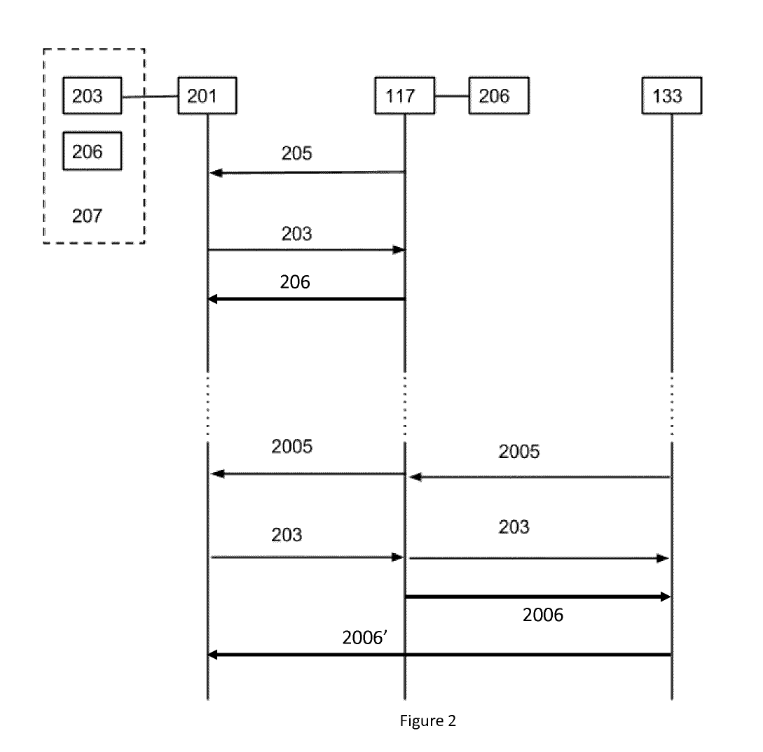

FIG. 2 is a schematic representation of a message flow for a system according to an example. A tag 201 is provided, such as at the point of manufacture, with a unique identifier 203, which can be stored in a reserved area of memory to prevent tampering. The identifier is communicated to cloud-based apparatus 117 in response to a request 205 from apparatus 117 to tag 201. Alternatively, identifier 203 can be provided by tag 201 without a request, such as when the tag is first powered. Apparatus 117 can use the identifier 203 to determine data 206 to be associated with the tag, which data can be modified and updated as desired. For example, data 206 can be mapped to identifier 203. Data 206 can represent information for a medicament and a dosage regime for the medicament. The data 206 is transmitted to tag 201 and stored in a memory 207 of the tag. The data 206 can also include information relating to the user of the system, such as a patient for example. This information can include data from a medical record of the user and include vital statistics of the user as well as other information such as other medications that are prescribed for the user. Apparatus 117 can compare a list of prescribed medication against a list of known interactions, and can provide a warning signal for display to a user to indicate a possible interaction between medicaments, and/or an indication that the user should consult a medical practitioner. The signal can give an indication of the medicaments that are considered to interact in a potentially adverse manner.

In an alternative example, also depicted in FIG. 2, a request 2005 can be transmitted from device 133 to apparatus 117. Apparatus 117 can forward the request 2005 to the tag 201. The request may be reframed by apparatus 117 according to a specific protocol associated with the tag 201 so that the tag recognises the request. For example, a header may be added to the request. The identifier 203 is communicated to cloud-based apparatus 117 in response to the request 2005, and can be forwarded to device 133. Before it is forwarded to device 133, the identifier can be used by apparatus 117 to provide information relevant to tag 201 for the device 133. For example, information for a medicament and dosage regime, which can include patient information as noted above, can be determined at apparatus 117 using identifier 203, and the identifier and the information 2006 can then be forwarded to device 133. Device 133 can be used to review, augment and/or modify the information 2006 before transmission 2006′ to tag 201, either directly or via apparatus 117.

Communication traffic can be provided using HTTPS protocol utilising SSUTLS. End users can be required to log on to apparatus 117 with a username and password, which passwords may be encrypted for example.

External devices, such as device 133 for example, can connect to an API and can be authorised using typical authorisation protocols. A user, via a website, can authorise the device to be able to use only the API that they grant permission to. As part of this granting process the device receives a token that it presents when calling the API. This token is checked to be valid and not revoked and also against the access control framework to ensure that it is authorised for each API call. Using this technique the user's username and password are never shared with the device or any 3rd party and the user can at any time chose to revoke the token.

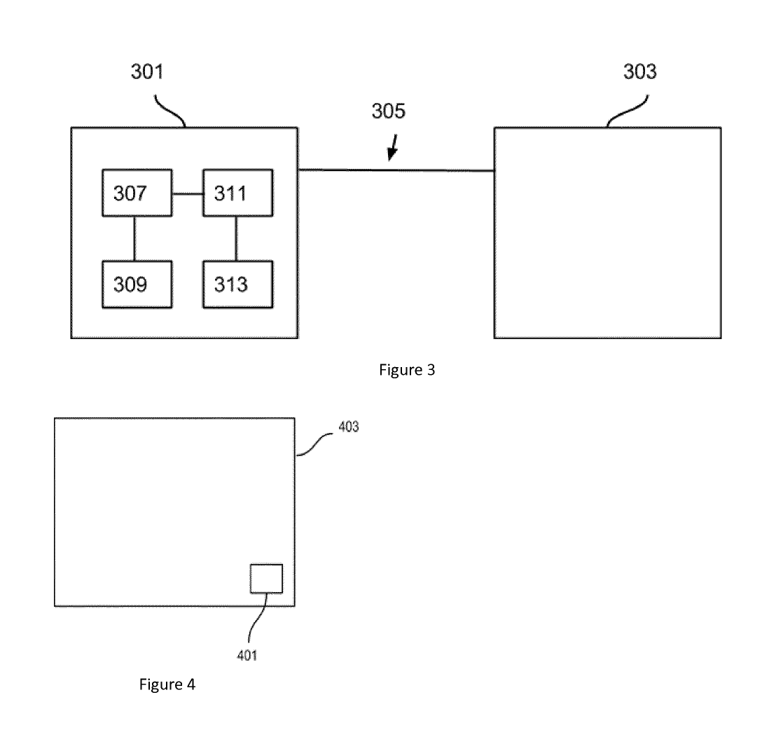

FIG. 3 is a schematic representation of a tag/display combination according to an example. In the example of FIG. 3, a tag 301 is connected to a display device 303 using wiring 305. Alternatively, the tag 301 and display 303 can include respective wireless transceivers, such as short range RF transceivers to effect a wireless link between the parts. Tag 301 can be in the form of an integrated circuit incorporating a central processing unit 307, random access memory 309 and a wireless transceiver 311, which can be encapsulated to form a tag up to several mm² for example. The IC can be a complementary metal-oxide semiconductor (CMOS) device, with integrated wireless data I/O and an on-chip antenna 313.

FIG. 4 is a schematic representation of a tag/display combination according to an example. In the example of FIG. 4, a tag 401 is provided as part of or otherwise encapsulated with, attached to, or associated with a display 403. For example, tag 401 can be encapsulated in an outer coating of display 403, or can be adhered to part of the display 403 and so on.

1. A medication reminder system, comprising:
a control device operable to receive data representing a dosage regime for the medication for use with an electronic tag, the tag communicatively coupled to a display device to be placed on or in association with an item containing the medication, the tag including a transceiver operable to send and receive data to and from the control device, wherein the display device is operable to display an indicator representing the dosage regime or a parameter associated with the dosage regime.

2. (canceled)

3. A medication reminder system as claimed in claim 1, wherein the display device is a reflective mode guest-host liquid crystal display.

4. A medication reminder system as claimed in claim 1, wherein the display is flexible.

5. A medication reminder system as claimed in claim 1, wherein the data representing a dosage regime for the medication is transmitted from the control device to the tag.

6. A medication reminder system as claimed in claim 1, wherein the electronic tag includes input means to provide input data representing confirmation of adherence to the dosage regime.

7. (canceled)

8. A medication reminder system as claimed in claim 1, wherein the control device is operable to receive or transmit data representing the dosage regime from or to apparatus at a remote location.

9. A medication reminder system as claimed in claim 8, wherein the apparatus at the remote location is a cloud-based server.

10. A medication reminder system as claimed in claim 8, wherein the apparatus is operable to process the data representing the dosage regime to provide an indication representing risk stratification associated with adherence to the dosage regime.

11. A medication reminder system as claimed in claim 1, further including an additional display device operable to receive data from the control device.

12. A medication reminder system as claimed in claim 11, wherein the additional display device is a summary display operable to display information representing a summary from one or more input sources.

13. A medication reminder system as claimed in claim 11, wherein the additional display is operable to display data representing a risk stratified summary of the adherence across multiple medications.

14. A medication reminder system as claimed in claim 11, wherein the additional display device is located in a geographically remote location from the control device, tag and display device and the additional display device is operable to receive data from the apparatus at another remote location.

15. (canceled)

16. A medication reminder system as claimed in claim 1, wherein the data representing the dosage regime is input to a memory of the electronic tag using the input means.

17. A medication reminder system as claimed in claim 1, wherein the apparatus is operable to receive data representing multiple dosage regimes for respective ones of multiple different medicaments.

18. A computer-implemented method for providing a medication reminder, comprising:
receiving data representing a dosage regime for the medication at a control device for use with an electronic tag communicatively coupled to a display device located on or in association with an item containing the medication;
displaying an indicator representing the dosage regime on the display device or a parameter associated with the dosage regime;
transmitting the data representing a dosage regime for the medication from the control device to the tag; and
providing or generating input data representing confirmation of adherence to the dosage regime using input means of the electronic tag.

19-21. (canceled)

22. A method as claimed in claim 18, wherein the input means are passive, and providing input data includes inferring user activity using one or more sensors, such as an accelerometer and/or light sensor.

23. A method as claimed in claim 18, further including, at the control device, receiving or transmitting data representing the dosage regime from or to apparatus at a remote location.

24. A method as claimed in claim 18, further including processing the data representing the dosage regime and dose usage, and using the processed data, providing an indication representing risk stratification associated with adherence to the dosage regime.

25. A method as claimed in claim 18, further including displaying the indicator on an additional, summary, display device and receiving data from a remote apparatus for display using the additional display device.

26. (canceled)

27. A method as claimed in claim 25, further including receiving data from other feeds of information for display using the additional display device.

28-33. (canceled)
